(19) United States
(12) Patent Application Publication
(10) Pub. No.: US 2020/0361291 A1
(43) Pub. Date: Nov. 19, 2020

(54) Deployable Window Screen Assembly

(71) Applicant: Pamela Zolotko, Vancouver, WA (US)

(72) Inventor: Pamela Zolotko, Vancouver, WA (US)

(21) Appl. No.: 16/413,001

(22) Filed: May 15, 2019

(51) Int. Cl. B60J 1/20

(52) U.S. Cl. CPC B60J 1/2011

(57) ABSTRACT

A deployable window screen assembly includes a primary screen that is positionable in the open window of the vehicle door to inhibit animals in the vehicle from escaping through the open window. The primary screen is comprised of an air permeable material to ventilate an interior of the vehicle. The primary screen is coupled to a bracing unit and the bracing unit engages each of a top side and a bottom side of the open window of the vehicle door. A secondary screen is removably coupled to the bracing unit to cover the open window when the primary screen has an insufficient width to cover the open window. The secondary screen is comprised of an air permeable material to ventilate the interior of the vehicle.

### CROSS-REFERENCE TO RELATED APPLICATIONS

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to screen devices and more particularly pertains to a new screen device for inhibiting animals from escaping through an open window of a vehicle door.

### BRIEF SUMMARY OF THE INVENTION

An embodiment of the disclosure meets the needs presented above by generally comprising a primary screen that is positionable in an open window of a vehicle door to inhibit animals in the vehicle from escaping through the open window. The primary screen is comprised of an air permeable material to ventilate an interior of the vehicle. The primary screen is coupled to a bracing unit and the bracing unit engages each of a top side and a bottom side of the open window of the vehicle door. A secondary screen is removably coupled to the bracing unit to cover the open window when the primary screen has an insufficient width to cover the open window. The secondary screen is comprised of an air permeable material to ventilate the interior of the vehicle.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front perspective view of a deployable window screen assembly according to an embodiment of the disclosure.

FIG. 2 is a right side view of an embodiment of the disclosure.

FIG. 3 is a left side view of an embodiment of the disclosure.

FIG. 4 is a back view of an embodiment of the disclosure.

FIG. 5 is a perspective in-use view of an embodiment of the disclosure.

FIG. 6 is a cross sectional view taken along line 6-6 of FIG. 4 of an embodiment of the disclosure.

### DETAILED DESCRIPTION OF THE INVENTION

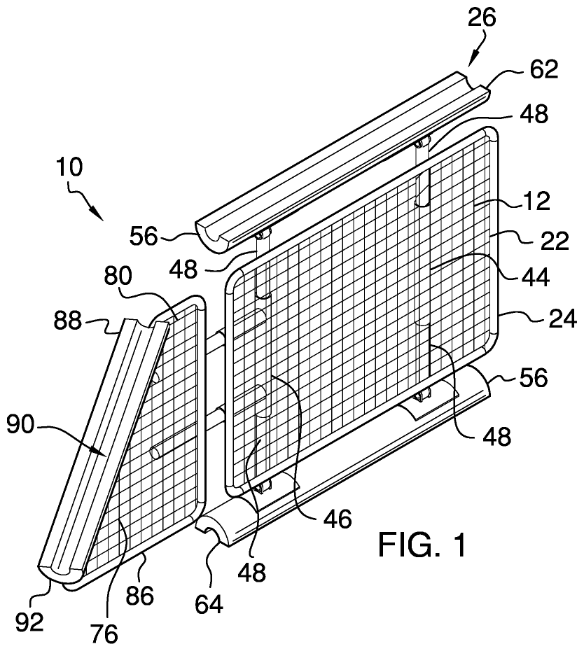

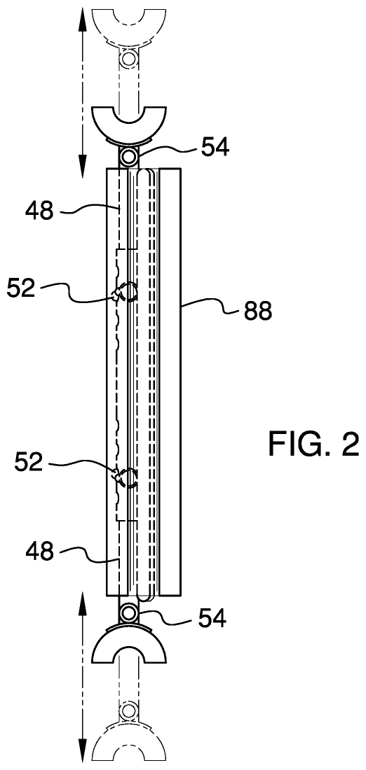

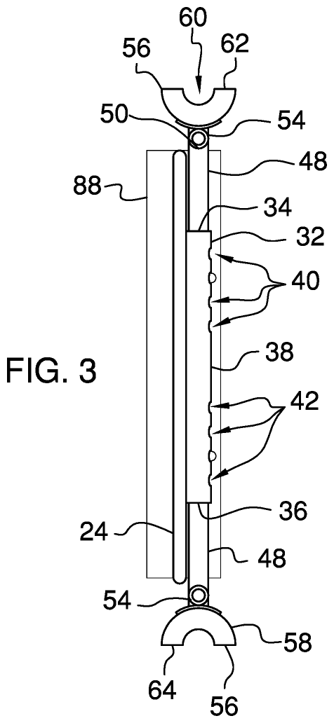

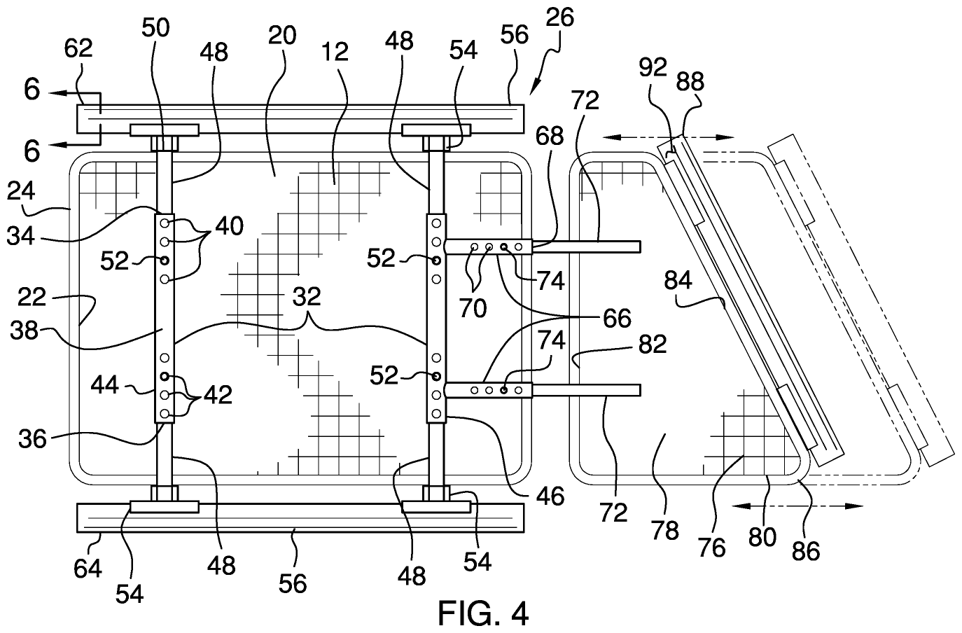

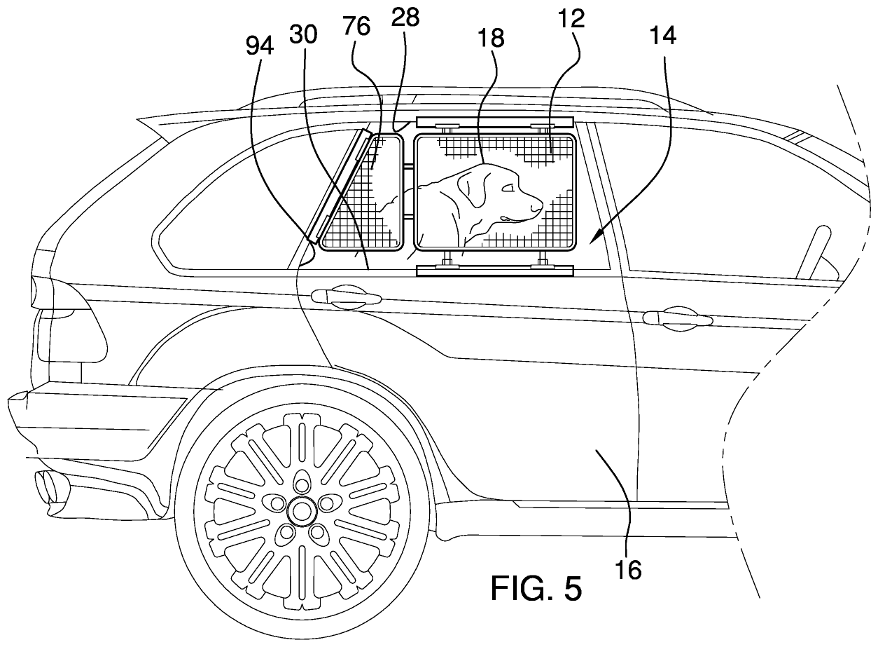

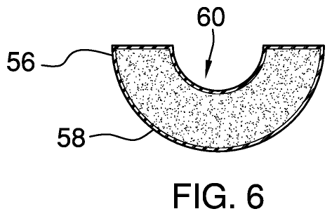

With reference now to the drawings, and in particular to FIGS. 1 through 6 thereof, a new screen device embodying the principles and concepts of an embodiment of the disclosure and generally designated by the reference numeral 10 will be described.

As best illustrated in FIGS. 1 through 6, the deployable window screen assembly 10 generally comprises a primary screen 12 that is positionable in an open window 14 of a vehicle door 16. In this way the primary screen 12 inhibits an animal 18 in the vehicle from escaping through the open window 14. The vehicle door 16 may be on a passenger vehicle or other motorized vehicle in which the animal 18 is riding, and the animal 18 may be a dog, a cat or other domesticated animal 18. The primary screen 12 is comprised of an air permeable material to ventilate an interior of the vehicle. In this way the primary screen 12 inhibits the animal 18 in the vehicle from being exposed to dangerously high temperatures. The primary screen 12 has a rear side 20 and a perimeter edge 22, and a primary frame 24 is coupled around the perimeter edge 22 of the primary screen 12 to retain the primary screen 12 in a flattened orientation. Additionally, the primary screen 12 may have a width of approximately 48.0 cm and a height of approximately 35.0 inches thereby facilitating the primary screen 12 to substantially cover the open window 14.

A bracing unit 26 is provided and the primary screen 12 is coupled to the bracing unit 26. The bracing unit 26 engages each of a top side 28 and a bottom side 30 of the open window 14 of the vehicle door 16 to retain the primary screen 12 in the open window 14. Additionally, the bracing unit 26 is positioned within the vehicle when the bracing unit 26 is positioned in the open window 14. In this way an individual is inhibited from removing the primary screen 12 from the open window 14. The bracing unit 26 comprises a pair of tubes 32 that each has a first end 34, a second end 36 and an outer wall 38 extending therebetween.

The outer wall 38 of each of the tubes 32 has a first set of apertures 40 each extending an interior of the tubes 32. The first set of apertures 40 that is spaced apart from each other and is distributed from the first end 34 toward the second end 36 of a respective one of the tubes 32. The outer wall 38 of each of the tubes 32 has a second set of apertures 42 each extending an interior of the tubes 32. The second set of apertures 42 is spaced apart from each other and is distributed from the second end 36 toward the first end 34 of a respective one of the tubes 32.

The pair of tubes 32 includes a first tube 44 and a second tube 46. The outer wall 38 of each of the first 44 and second 46 tubes has the rear side 20 of the screen coupled thereto. Each of the first 44 and second 46 tubes is spaced apart from each other and is oriented coextensive with each other on the primary screen 12. Moreover, each of the first 34 and second 36 ends of each of the first 44 and second 46 tubes is spaced from the perimeter edge 22 of the primary screen 12.

The bracing unit 26 includes a plurality of pipes 48 that is each slidably inserted into a respective one of the first 34 and second 36 ends of a respective one of the first 44 and second 46 tubes. Each of the pipes 48 has a distal end 50 with respect to the respective first 34 or second 36 end of the respective tube 32. A plurality of locks 52 is each movably coupled to a respective one of the pipes 48. Each of the locks 52 releasably engages a respective one of the first 40 and second 42 sets of apertures in a respective one of the first 44 or second 46 tubes. In this way each of the pipes 48 is retained at a selected length of extension with respect to the respective tube 32.

A plurality of pivots 54 is each pivotally coupled to the distal end 50 of a respective one of the pipes 48. Each of the pivots 54 has a respective one of the first 34 or second 36 ends of a respective one of the first 44 or second 46 tubes being associated therewith. A pair of brace saddles 56 is provided and each of the brace saddles 56 has a first surface 58 and a receiving channel 60 therein. The pair of brace saddles 56 includes a first brace saddle 62 and a second brace saddle 64.

The first surface 58 of the first brace saddle 62 is coupled to each of the pivots 54 that are associated with the first end 34 of the first 44 and second 46 tubes. In this way the receiving channel 60 in the first brace saddle 62 can engage the top side 28 of the open window 14. The first surface 58 of the second brace saddle 64 is coupled to each of the pivots 54 that are associated with the second end 36 of the first 44 and second 46 tubes. In this way the receiving channel 60 in the second brace saddle 64 can engage the bottom side 30 of the open window 14.

The bracing unit 26 includes a pair of extension tubes 66 that is each coupled to and extends laterally away from the second tube 46. Each of the extension tubes 66 has a distal end 68 with respect to the second tube 46 and each of the extension tubes 66 has a plurality of holes 70 extending therethrough. The holes 70 on each of the extension tubes 66 are spaced apart from each other and are distributed between the distal end 68 of the extension tubes 66 and the second tube 46. A pair of rods 72 is provided and the distal end 68 of each of the extension tubes 66 insertably receives a respective one of the rods 72.

A pair of rod locks 74 is each movably coupled to a respective one of the rods 72. Each of the rod locks 74 releasably engages a selected one of the holes 70 in a respective one of the extension tubes 66. Additionally, each of the rod locks 74 retains the respective rod 72 at a selected length with respect to the respective extension tube 66. Each of the rod locks 74 may comprise a ball that is biased outwardly from the respective rod 72 or the like.

A secondary screen 76 is removably coupled to the bracing unit 26 to cover the open window 14 when the primary screen 12 has an insufficient width to cover the open window 14. The secondary screen 76 is comprised of an air permeable material to ventilate the interior of the vehicle. The secondary screen 76 has a back side 78 and a peripheral edge 80, the peripheral edge 80 includes a front side 82 and a rear side 84, and the rear side 84 angles toward the front side 82. The back side 78 of the secondary screen 76 is coupled to each of the rods 72 such that the front side 82 of the peripheral edge 80 is spaceable a selected distance from the perimeter edge 22 of the primary screen 12.

A secondary frame 86 is coupled around the peripheral edge 80 of the secondary screen 76 such that the secondary frame 86 retains the secondary screen 76 in a flattened orientation. An extension saddle 88 is provided that has a receiving channel 90 therein and a lower surface 92. The lower surface 92 is coupled to the secondary frame 86 and the extension saddle 88 is positioned on the rear side 84 of the peripheral edge 80 of the secondary screen 76. In this way the receiving channel 90 in the extension saddle 88 can engage a back side 94 of the open window 14 in the door 16.

In use, the bracing unit 26 is positioned in the open window 14 such that the primary screen 12 faces outwardly on the vehicle door 16. Each of the first 62 and second 64 brace saddles are urged against the respective top 28 and bottom 30 sides of the open window 14. In this way the primary screen 12 covers the open window 14 to a degree that the animal 18 cannot escape through the open window 14. Moreover, the primary screen 12 facilitates the animal 18 to be left in the vehicle during sunny days without exposing the animal 18 to dangerously high temperatures. Each of the rods 72 on the secondary screen 76 is inserted into the respective extension tube when the primary screen 12 does not have sufficient width to cover the open window 14. The secondary screen 76 is spaced from the primary screen 12 sufficiently to facilitate the extension saddle 88 to engage the back side 78 of the open window 14.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A deployable window screen assembly being configured to be positioned in an open window of a vehicle door thereby facilitating an interior of the vehicle to be ventilated while inhibiting animals in the vehicle from escaping through the open window, said assembly comprising:
a primary screen being positionable in an open window of a vehicle door wherein said primary screen is configured to inhibit animals in the vehicle from escaping through the open window, said primary screen being comprised of an air permeable material wherein said primary screen is configured to ventilate an interior of the vehicle thereby inhibiting the animals in the vehicle from being exposed to dangerously high temperatures;
a bracing unit having said primary screen being coupled thereto, said bracing unit engaging each of a top side and a bottom side of the open window of the vehicle door wherein said bracing unit is configured to retain said primary screen in the open window, said bracing unit being positioned within the vehicle when said bracing unit is positioned in the open window wherein said bracing unit is configured to inhibit an individual from removing said primary screen from the open window; and
a secondary screen being removably coupled to said bracing unit wherein said secondary screen is configured to cover the open window when said primary screen has an insufficient width to cover the open window, said secondary screen being comprised of an air permeable material wherein said secondary screen is configured to ventilate the interior of the vehicle.

2. The assembly according to claim 1, wherein:
said primary screen has a rear side and a perimeter edge; and
said assembly includes a primary frame being coupled around said perimeter edge of said primary screen such that said primary frame retains said primary screen in a flattened orientation.

3. The assembly according to claim 2, wherein:
said bracing unit comprises a pair of tubes, each of said tubes having a first end, a second end and an outer wall extending therebetween;
said outer wall of each of said tubes has a first set of apertures each extending an interior of said tubes, said first set of apertures being spaced apart from each other and being distributed from said first end toward said second end of a respective one of said tubes; and
said outer wall of each of said tubes has a second set of apertures each extending an interior of said tubes, said second set of apertures being spaced apart from each other and being distributed from said second end toward said first end of a respective one of said tubes.

4. The assembly according to claim 3, wherein said pair of tubes includes a first tube and a second tube, said outer wall of each of said first and second tubes having said rear side of said screen being coupled thereto, each of said first and second tubes being spaced apart from each other and being oriented coextensive with each other on said primary screen, each of said first and second ends of each of said first and second tubes being spaced from said perimeter edge of said primary screen.

5. The assembly according to claim 4, wherein said bracing unit includes a plurality of pipes, each of said pipes being slidably inserted into a respective one of said first and second ends of a respective one of said first and second tubes, each of said pipes having a distal end with respect to said respective first or second end of said respective tube.

6. The assembly according to claim 5, wherein said bracing unit includes a plurality of locks, each of said locks being movably coupled to a respective one of said pipes, each of said locks releasably engaging a selected one of a respective first and second sets of apertures in a respective one of said first or second tubes thereby retaining each of said pipes at a selected length of extension with respect to said respective tube.

7. The assembly according to claim 6, wherein said bracing unit includes a plurality of pivots, each of said pivots being pivotally coupled to said distal end of a respective one of said pipes, each of said pivots having a respective one of said first or second ends of a respective one of said first or second tubes being associated therewith.

8. The assembly according to claim 7, wherein said bracing unit includes a pair of brace saddles, each of said brace saddles having a first surface and a receiving channel therein, said pair of brace saddles including a first brace saddle and a second brace saddle, said first surface of said first brace saddle being coupled to each of said pivots being associated with said first end of said first and second tubes wherein said receiving channel in said first brace saddle is configured to engage the top side of the open window, said first surface of said second brace saddle being coupled to each of said pivots being associated with said second end of said first and second tubes wherein said receiving channel in said second brace saddle is configured to engage the bottom side of the open window.

9. The assembly according to claim 4, wherein said bracing unit includes a pair of extension tubes, each of said extension tubes being coupled to and extending laterally away from said second tube, each of said extension tubes having a distal end with respect to said second tube, each of said extension tubes having a plurality of holes extending therethrough, said holes on each of said extension tubes being spaced apart from each other and being distributed between said distal end of said extension tubes and said second tube.

10. The assembly according to claim 9, wherein said bracing unit includes a pair of rods, said distal end of each of said extension tubes insertably receiving a respective one of said rods.

11. The assembly according to claim 10, wherein said bracing unit includes a pair of rod locks, each of said rod locks being movably coupled to a respective one of said rods, each of said rod locks releasably engaging a selected one of said holes in a respective one of said extension tubes, each of said rod locks retaining said respective rod at a selected length with respect to said respective extension tube.

12. The assembly according to claim 4, wherein:
said secondary screen has a back side and a peripheral edge, said peripheral edge including a front side and a back side, said back side angling toward said front side, each of said rods having said back side of said secondary screen being coupled thereto such that said front side is spaceable a selected distance from said perimeter edge of said primary screen; and
said assembly includes a secondary frame being coupled around said peripheral edge of said secondary screen such that said secondary frame retains said secondary screen in a flattened orientation.

13. The assembly according to claim 12, further comprising an extension saddle having a receiving channel therein and a lower surface, said lower surface being coupled to said secondary frame, said extension saddle being positioned on said back side of said peripheral edge of said secondary screen wherein said receiving channel in said extension saddle is configured to engage a back side of the open window in the door.

14. A deployable window screen assembly being configured to be positioned in an open window of a vehicle door thereby facilitating an interior of the vehicle to be ventilated while inhibiting animals in the vehicle from escaping through the open window, said assembly comprising:
a primary screen being positionable in an open window of a vehicle door wherein said primary screen is configured to inhibit animals in the vehicle from escaping through the open window, said primary screen being comprised of an air permeable material wherein said primary screen is configured to ventilate an interior of the vehicle thereby inhibiting the animals in the vehicle from being exposed to dangerously high temperatures, said primary screen having a rear side and a perimeter edge;
a primary frame being coupled around said perimeter edge of said primary screen such that said primary frame retains said primary screen in a flattened orientation;
a bracing unit having said primary screen being coupled thereto, said bracing unit engaging each of a top side and a bottom side of the open window of the vehicle door wherein said bracing unit is configured to retain said primary screen in the open window, said bracing unit being positioned within the vehicle when said bracing unit is positioned in the open window wherein said bracing unit is configured to inhibit an individual from removing said primary screen from the open window, said bracing unit comprising:
a pair of tubes, each of said tubes having a first end, a second end and an outer wall extending therebetween, said outer wall of each of said tubes having a first set of apertures each extending an interior of said tubes, said first set of apertures being spaced apart from each other and being distributed from said first end toward said second end of a respective one of said tubes, said outer wall of each of said tubes having a second set of apertures each extending an interior of said tubes, said second set of apertures being spaced apart from each other and being distributed from said second end toward said first end of a respective one of said tubes, said pair of tubes including a first tube and a second tube, said outer wall of each of said first and second tubes having said rear side of said screen being coupled thereto, each of said first and second tubes being spaced apart from each other and being oriented coextensive with each other on said primary screen, each of said first and second ends of each of said first and second tubes being spaced from said perimeter edge of said primary screen;
a plurality of pipes, each of said pipes being slidably inserted into a respective one of said first and second ends of a respective one of said first and second tubes, each of said pipes having a distal end with respect to said respective first or second end of said respective tube;
a plurality of locks, each of said locks being movably coupled to a respective one of said pipes, each of said locks releasably engaging a selected one of a respective first and second sets of apertures in a respective one of said first or second tubes thereby retaining each of said pipes at a selected length of extension with respect to said respective tube;
a plurality of pivots, each of said pivots being pivotally coupled to said distal end of a respective one of said pipes, each of said pivots having a respective one of said first or second ends of a respective one of said first or second pipes being associated therewith;
a pair of brace saddles, each of said brace saddles having a first surface and a receiving channel therein, said pair of brace saddles including a first brace saddle and a second brace saddle, said first surface of said first brace saddle being coupled to each of said pivots being associated with said first end of said first and second tubes wherein said receiving channel in said first brace saddle is configured to engage the top side of the open window, said first surface of said second brace saddle being coupled to each of said pivots being associated with said second end of said first and second tubes wherein said receiving channel in said second brace saddle is configured to engage the bottom side of the open window;
a pair of extension tubes, each of said extension tubes being coupled to and extending laterally away from said second tube, each of said extension tubes having a distal end with respect to said second tube, each of said extension tubes having a plurality of holes extending therethrough, said holes on each of said extension tubes being spaced apart from each other and being distributed between said distal end of said extension tubes and said second tube;
a pair of rods, said distal end of each of said extension tubes insertably receiving a respective one of said rods; and
a pair of rod locks, each of said rod locks being movably coupled to a respective one of said rods, each of said rod locks releasably engaging a selected one of said holes in a respective one of said extension tubes, each of said rod locks retaining said respective rod at a selected length with respect to said respective extension tube;
a secondary screen being removably coupled to said bracing unit wherein said secondary screen is configured to cover the open window when said primary screen has an insufficient width to cover the open window, said secondary screen being comprised of an air permeable material wherein said secondary screen is configured to ventilate the interior of the vehicle, said secondary screen having a back side and a peripheral edge, said peripheral edge including a front side and a back side, said back side angling toward said front side, each of said rods having said back side of said secondary screen being coupled thereto such that said front side is spaceable a selected distance from said perimeter edge of said primary screen;
a secondary frame being coupled around said peripheral edge of said secondary screen such that said secondary frame retains said secondary screen in a flattened orientation; and
an extension saddle having a receiving channel therein and a lower surface, said lower surface being coupled to said secondary frame, said extension saddle being positioned on said back side of said peripheral edge of said secondary screen wherein said receiving channel in said extension saddle is configured to engage a back side of the open window in the door.
